(19) United States
(12) Patent Application Publication
(10) Pub. No.: US 2005/0093673 A1
(43) Pub. Date: May 5, 2005

(54) System and method of locking/unlocking using mobile communication terminals

(75) Inventor: Do Young Kwon, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Curitel Communications, Inc.

(21) Appl. No.: 10/959,935

(22) Filed: Oct. 6, 2004

(30) Foreign Application Priority Data
Oct. 8, 2003 (KR) 10-2003-0069922

(51) Int. Cl. G06F 7/04; G06F 7/00

(52) U.S. Cl. 340/5.2; 382/100; 340/5.21; 348/161; 235/382.5

(57) ABSTRACT

Disclosed are a system and a method of locking/unlocking using mobile communication terminals. The system comprises: a mobile communication terminal comprising a locking/unlocking key block for displaying multi-media message, pre-stored in the mobile communication terminal or received from other mobile communication terminal, as a locking/unlocking key; and a locking apparatus comprising a locking/unlocking control block for sensing the multi-media message displayed by the mobile communication terminal, determining whether the sensed multi-media message is coincident with multi-media message preset in the locking apparatus or not and, thus, controlling the locking apparatus. Accordingly, it is possible to open a door lock only with the mobile communication terminal, and to copy and transmit the key of the door lock to other users anywhere at any time. In addition, it is inexpensive to copy and transmit the key of the door lock.

### CROSS-REFERENCE TO RELATED APPLICATION

The entire disclosure of Korean Patent Application No. 10-2003-0069922 filed on Oct. 8, 2003 including specification, claims, drawings and summary, is incorporated herein by reference in its entirety.

### BACKGROUND OF THE INVENTION

1. Field of the Invention

The present invention relates to a system and a method of locking/unlocking using mobile communication terminals. More particularly, the present invention relates to a system and a method of locking/unlocking, which may lock and unlock a locking apparatus by using multi-media messages of mobile communication terminals.

2. Description of the Related Art

Generally, for a system that a key or card key is used to lock and unlock a door lock provided in a house (for example, entrance door) or an office, a user should carry the key or card key to lock and unlock the locking apparatus. In other words, for the above locking apparatus, in a point that the apparatus cannot be unlocked without the key or card key, it can be said that the apparatus effectively performs the locking role.

In this connection, the key or card key is distributed to limited number of users and is not usually copied, to keep maintaining the locking role. Accordingly, it has difficulties that the locking apparatus should be changed when the key or card key is lost through user's carelessness.

Accordingly, there is a need for a system or an apparatus capable of locking and unlocking a locking apparatus by using a mobile communication terminal, which is always carried due to developments of the terminal, in place of the key or card key in the related art. Thus, it is possible to unlock the door lock only with the mobile communication terminal even without the key or card key and to transfer a key of the door lock to other users with the mobile communication terminal anywhere at any time.

### BRIEF SUMMARY OF THE INVENTION

Accordingly, the present invention has been made to solve the above-mentioned problems occurring in the related art. The object of the present invention is to provide a system and a method capable of performing locking/unlocking operations by using multi-media messages of a mobile communication terminal.

The other object of the present invention is to lock and unlock a door lock provided in home or an office only with multi-media messages of a mobile communication terminal in place of a key or card key and, thus, to provide a convenience of opening the door lock only with the mobile communication terminal without carrying the key or card key.

The object of the invention is to easily copy and transfer a locking/unlocking key of the door lock to other users anywhere at any time without limiting the number of users using mobile communication terminals and to inexpensively copy and transfer the locking/unlocking key.

In order to accomplish the objects, there is provided a locking/unlocking system using mobile communication terminals comprising: a mobile communication terminal comprising a locking/unlocking key block for displaying multi-media message, pre-stored in the mobile communication terminal or received from other mobile communication terminal, as a locking/unlocking key; and a locking apparatus comprising a locking/unlocking control block for sensing the multi-media message displayed by the mobile communication terminal, determining whether the sensed multi-media message is coincident with multi-media message preset in the locking apparatus or not and, thus, controlling the locking apparatus.

Preferably, the locking/unlocking key block may comprise: an input unit for supplying input signals to a control unit when user's function button input is sensed; a memory unit for storing the multi-media message corresponding to the locking/unlocking key of the locking apparatus in a specific data area; the control unit for searching the memory unit to display the multi-media message after receiving the input signals from the input unit; and a screen display unit for displaying the multi-media message in an image form according to control of the control unit.

Preferably, the locking/unlocking key block may further comprise a transmitting/receiving unit for transmitting the multi-media message to other mobile communication terminals via a multi-media message service or receiving multi-media message from other mobile communication terminals to store the received multi-media message in the memory unit.

Preferably, the locking/unlocking key block may further comprise: a camera for photographing a locking/unlocking key-related image displayed on a screen display unit of other mobile communication terminal or an actual locking/unlocking key and converting the photographed image into a video signal; and a display sensor unit for receiving the video signal from the camera, converting the signal into multi-media message and storing the multi-media message in the memory unit.

Preferably, the locking/unlocking control block may comprise: a camera for photographing the multi-media message displayed by the locking/unlocking key block and converting the multi-media message into a video signal; a display sensor unit for receiving the video signal from the camera and converting the signal into multi-media message; a memory unit for presetting multi-media message corresponding to the locking/unlocking key to be used in the locking apparatus and storing the multi-media message in a specific data area; and a comparison-control unit for receiving the multi-media message from the display sensor unit, comparing the received multi-media message with the multi-media message preset in the memory unit to know whether they are coincident with each other or not, and controlling locking/unlocking operations of the locking apparatus.

Differently, there is provided a locking/unlocking method using mobile communication terminals comprising the acts of: receiving multi-media message from a mobile communication terminal and sensing the received multi-media message; comparing the received multi-media message with preset multi-media message to know whether they are coincident with each other or not; and controlling locking/unlocking operations of a locking apparatus when the received multi-media message is coincident with the preset multi-media message as a result of the comparison.

Preferably, the act of sensing the received multi-media message is to receive the multi-media message as a video signal and to convert the video signal into multi-media message.

Preferably, the multi-media message received from the mobile communication terminal may be one of multi-media message stored in the mobile communication terminal and multi-media message that the mobile communication terminal received from other mobile communication terminals.

Preferably, the preset multi-media message may be stored in the locking apparatus.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a configuration of a locking/unlocking system using mobile communication terminals according to a preferred embodiment of the present invention; and

FIG. 2 is a flow chart showing a locking/unlocking method using mobile communication terminals according to a preferred embodiment of the present invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

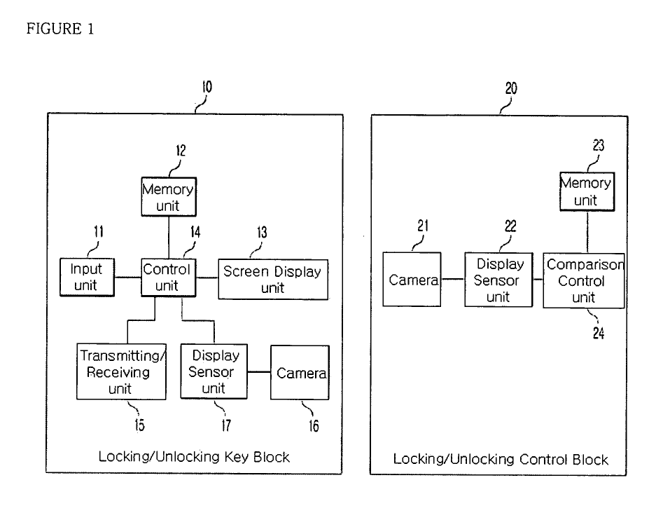

As shown in FIG. 1, a configuration of a locking/unlocking system using mobile communication terminals according to a preferred embodiment of the present invention can be largely divided into a locking/unlocking key block 10 in the mobile communication terminal and a locking/unlocking control block 20 in a locking apparatus.

The locking/unlocking key block 10 stores multi-media message corresponding to a locking/unlocking key of the locking apparatus in a specific data area and displays the multi-media message on a screen when locking or unlocking the locking apparatus. In addition, the locking/unlocking key block 10 transmits the multi-media message to users requiring the locking/unlocking key of the locking apparatus via a multi-media message service.

The locking/unlocking key block 10 comprises an input unit 10, a memory unit 12, a screen display unit 13 and a control unit 14. Alternatively, the locking/unlocking key block 10 further comprises a transmitting/receiving unit 15. Also, alternatively, the locking/unlocking key block 10 further comprises a camera 16 and a display sensor unit 17.

The input unit 11 supplies search input signal to the control unit 14 when input of search function button for searching multi-media message corresponding to the locking/unlocking key of the locking apparatus is sensed. Further, the input unit 11 supplies select input signal to the control unit 14 when input of select function button for selecting multi-media message to be used from searched multi-media messages is sensed. Alternatively, the input unit 11 supplies transmitting input signal to the control unit 14 when input of transmitting function button for transmitting the selected multi-media message to other user who needs the locking/unlocking key of the locking apparatus. Also alternatively, the input unit 11 supplies store input signal to the control unit 14 when input of store function button for storing multi-media message received from other users is sensed.

The memory unit 12 serves to store the multi-media message corresponding to the locking/unlocking key of the locking apparatus in a specific data area and to output the multi-media message from the specific data area, according to control of the control unit 14.

The screen display unit 13 serves to display multi-media messages to be searched and the multi-media message selected by the user in an image form, according to control of the control unit 14. Alternatively, the screen display unit 13 serves to display the multi-media message applied from the transmitting/receiving unit 15, according to control of the control unit 14.

The control unit 14 executes control operations according to input signals supplied from the input unit 11. In other words, when search input signal is supplied from the input unit 11, the control unit 14 searches the specific data area of the memory unit 12 and controls the screen display unit 13 to display the multi-media messages to be searched. Also, when select input signal is supplied from the input unit 11, the control unit 14 controls the screen display unit 13 to display the multi-media message selected by the user in an image form. Alternatively, when transmitting/receiving input signal is supplied from the input unit 11, the control unit 14 applies the multi-media message selected by the user to the transmitting/receiving unit 15 or receives the multi-media message from the transmitting/receiving unit 15. Then, the control unit 14 controls the screen display unit 13 to display the multi-media message. Herein, when store input signal is supplied from the input unit 11, the control unit controls the memory unit 12 to store the multi-media message received from the transmitting/receiving unit 15 in the specific data area of the memory unit 12. Further, alternatively, the control unit 14 controls the memory unit 12 to store the multi-media messages applied from the display sensor unit 17 in the specific data area of the memory unit 12.

The transmitting/receiving unit 15 converts the multi-media message applied by the control unit 14 into a transmit signal for performing a wireless communication and transmits the converted multi-media message to users requiring the locking/unlocking key of the locking apparatus via a multi-media message service. Also, when the transmitting/receiving unit 15 receives a locking/unlocking key of the locking apparatus-related signal from other users through wireless communication, the transmitting/receiving unit 15 converts the signal into multi-media message and applies the converted message to the control unit 14.

The camera 16 photographs the locking/unlocking key of the locking apparatus-related image (or an actual locking/unlocking key), converts the image into a video signal and applies the signal to the display sensor unit 17.

The display sensor unit 17 receives the video signal from the camera 16, converts the signal into multi-media message and applies the message to the control unit 14.

On the other hand, the locking/unlocking control block 20 comprises a camera 21, a display sensor unit 22, a memory unit 23 and a comparison-control unit 24.

The camera 21 and the display sensor unit 22 of the locking/unlocking control block 20 senses multi-media message that the locking/unlocking key block 10 displayed. Then, the locking/unlocking control block 20 compares the multi-media message with a multi-media message preset as a locking/unlocking key and performs locking/unlocking operations in case that the multi-media message sensed by the locking/unlocking control block 20 is coincident with the multi-media message preset in the locking/unlocking control block 20.

The camera 21 photographs a locking/unlocking key of the locking apparatus-related image displayed in the screen display unit 13 of the locking/unlocking key block 10, converts the image into a video signal and applies the signal to the display sensor unit 22.

The display sensor unit 22 receives the video signal applied from the camera 21, converts the video signal into multi-media message and applies the converted message to the comparison-control unit 24.

The memory unit 23 presets a multi-media message corresponding to a locking/unlocking key to be used in the locking apparatus by a user, stores the preset message in a specific data area and outputs the stored message according to control of the comparison-control unit 24.

The comparison-control unit 24 reads the multi-media message stored in the memory unit 23 and compares the read message with multi-media message applied from the display sensor unit 22. In case that the compared messages are coincident with each other, the comparison-control unit 24 controls the locking apparatus to perform locking/unlocking operations.

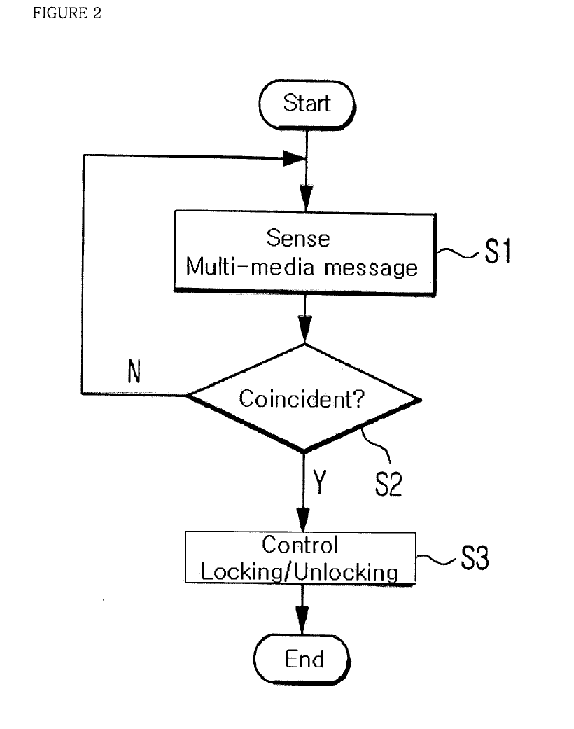

Operations of the locking/unlocking system using mobile communication terminals according to an embodiment of the present invention will be described with reference to FIG. 2.

A multi-media message corresponding to a locking/unlocking key of a locking apparatus is pre-stored in a storing unit (i.e. memory unit) of a locking/unlocking control block. A multi-media message, which is sensed by the locking apparatus, inputted from a mobile communication terminal is pre-stored in a storing unit of the mobile communication terminal or received from other mobile communication terminals.

First, the locking/unlocking control block of the locking apparatus senses the multi-media message inputted by the mobile communication terminal (S1).

Then, the locking/unlocking control block compares the multi-media message with the multi-media message stored in the storing unit (e.g. memory unit) of the locking/unlocking control block to know whether the multi-media message inputted by the mobile communication terminal is coincident with the multi-media message stored in the storing unit of the locking/unlocking control block or not, and, thus, determines whether the multi-media message inputted from the mobile communication terminal corresponds to the locking/unlocking key or not (S2).

As a result of the determination, when the multi-media message inputted form the mobile communication terminal is coincident with the multi-media message stored in the storing unit of the locking/unlocking control block, locking/unlocking operations of the locking apparatus can be performed under control (S3).

The above operations will be explained in more details with reference to a block diagram of FIG. 1.

First, the multi-media message corresponding to the locking/unlocking key of the locking apparatus is preset and stored in a specific data area of the memory unit 23 of the locking apparatus.

When input of the search function button is sensed, the input unit 11 supplies search input signal to the control unit 14 of the mobile communication terminal. The control unit 14 controls the screen display unit 13 of the mobile communication terminal to display the multi-media messages.

Then, when input of select function button is sensed, the input unit 11 supplies the select input signal to the control unit 14. The control unit 14 that received the select input signal controls the screen display unit 13 to display the selected multi-media message in an image form.

And then, in order to use the multi-media message displayed by the screen display unit 13 as key for the locking/unlocking apparatus instead of the previously used key or card key, the camera 21 photographs the image displayed by the screen display unit 13, converts the image into a video signal and, then, applies the signal to the display sensor unit 22.

As a result of that, the display sensor unit 22 receives the video signal from the camera 21, converts the signal into multi-media message and applies the message to the comparison-control unit 24.

Then, the comparison-control unit 24 reads the multi-media message pre-stored in the memory unit 23, and then compares the multi-media message applied from the display sensor unit 22 with the multi-media message pre-stored in the memory unit 23.

As a result of the comparison, in case that the multi-media message applied from the display sensor unit 22 is coincident with the multi-media message pre-stored in the memory unit 23, the comparison-control unit 24 controls operation unit (not shown) of the locking/unlocking apparatus to perform locking/unlocking operations.

Meanwhile, when input of transmitting function button for transmitting the multi-media message to mobile communication terminals requiring the locking/unlocking key of the locking apparatus is sensed, the input unit 11 supplies the transmitting input signal to the control unit 14.

The control unit 14 checks the inputted signal supplied from the input unit 11, and then applies the multi-media message to the transmitting/receiving unit 15 of the locking apparatus.

Hence, the transmitting/receiving unit 15 converts the multi-media message applied by the control unit 14 into a transmit signal for performing a wireless communication and transmits the converted signal to other mobile communication terminals requiring the locking/unlocking key of the locking apparatus via a multi-media message service, thereby making it possible for the other mobile communication terminals, which do not store the multi-media message, to perform locking/unlocking operations by using the multi-media message.

Meanwhile, when a locking/unlocking key of the locking apparatus-related signal is received from other mobile communication terminals via a wires communication, the transmitting/receiving unit 15 converts the received signal into multi-media message and applies the message to the control unit 14.

Then, the control unit 14 receives the multi-media message from the transmitting/receiving unit 15 and controls the screen display unit 13 to display the multi-media message. At this time, in case that input of store function button is sensed, the input unit 11 supplies store input signal to the control unit 14.

Then, the control unit 14 checks the store input signal supplied from the input unit 11, and then stores the multi-media message in a specific data area of the memory unit 12, thereby making it possible to perform locking/unlocking operations by receiving multi-media message from other mobile communication terminals.

Alternatively, it is possible to apply a multi-media message to the display sensor unit 17 of the mobile communication terminal by photographing the locking/unlocking key of the locking apparatus-related image (or actual locking/unlocking key) through the camera 16 of the mobile communication terminal and converting the image into a video signal.

The display sensor unit 17 receives the video signal from the camera 16, converts the video signal into multi-media message and applies the message to the control unit 14. The control unit 14 stores the multi-media message applied from the display sensor unit 17 in a specific data area of the memory unit 12 to perform locking/unlocking operations with the stored message.

As explained above, according to the present invention, the locking/unlocking operations of the locking apparatus can be performed by using the multi-media message of the mobile communication terminal. Accordingly, it is possible to open a door lock only with the mobile communication terminal even though the key or card key is not carried, and to copy and transmit the key of the door lock to other users anywhere at any time due to the conveniences of carrying and communication of the mobile communication terminal. In addition, it is inexpensive to copy and transmit the key of the door lock.

While the invention has been shown and described with reference to certain preferred embodiments thereof, it will be understood by those skilled in the art that various changes in form and details may be made therein without departing from the spirit and scope of the invention as defined by the appended claims.

1. A locking/unlocking system using mobile communication terminals comprising:
a mobile communication terminal comprising a locking/unlocking key block for displaying multi-media message, pre-stored in the mobile communication terminal or received from other mobile communication terminal, as a locking/unlocking key; and
a locking apparatus comprising a locking/unlocking control block for sensing the multi-media message displayed by the mobile communication terminal, determining whether the sensed multi-media message is coincident with multi-media message preset in the locking apparatus or not and, thus, controlling the locking apparatus.

2. The locking/unlocking system according to claim 1, wherein the locking/unlocking key block comprises:
an input unit for supplying input signals to a control unit when user's function button input is sensed;
a memory unit for storing the multi-media message corresponding to the locking/unlocking key of the locking apparatus in a specific data area;
the control unit for searching the memory unit to display the multi-media message after receiving the input signals from the input unit; and
a screen display unit for displaying the multi-media message in an image form according to control of the control unit.

3. The locking/unlocking system according to claim 2, wherein the locking/unlocking key block further comprises a transmitting/receiving unit for transmitting the multi-media message to other mobile communication terminals via a multi-media message service or receiving multi-media message from other mobile communication terminals to store the received multi-media message in the memory unit.

4. The locking/unlocking system according to claim 2, wherein the locking/unlocking key block further comprises:
a camera for photographing a locking/unlocking key-related image displayed on a screen display unit of other mobile communication terminal or an actual locking/unlocking key and converting the photographed image into a video signal; and
a display sensor unit for receiving the video signal from the camera, converting the signal into multi-media message and storing the multi-media message in the memory unit.

5. The locking/unlocking system according to claim 1, wherein the locking/unlocking control block comprises:
a camera for photographing the multi-media message displayed by the locking/unlocking key block and converting the multi-media message into a video signal;
a display sensor unit for receiving the video signal from the camera and converting the signal into multi-media message;
a memory unit for presetting multi-media message corresponding to the locking/unlocking key to be used in the locking apparatus and storing the multi-media message in a specific data area; and
a comparison-control unit for receiving the multi-media message from the display sensor unit, comparing the received multi-media message with the multi-media message preset in the memory unit to know whether they are coincident with each other or not, and controlling locking/unlocking operations of the locking apparatus.

6. A locking/unlocking method using mobile communication terminals comprising the acts of:
receiving multi-media message from a mobile communication terminal and sensing the received multi-media message;
comparing the received multi-media message with preset multi-media message to know whether they are coincident with each other or not; and
controlling locking/unlocking operations of a locking apparatus when the received multi-media message is coincident with the preset multi-media message as a result of the comparison.

7. The method according to claim 6, wherein the act of sensing the received multi-media message is to receive the multi-media message as a video signal and to convert the video signal into multi-media message.

8. The method according to claim 6, wherein the multi-media message received from the mobile communication terminal is one of multi-media message stored in the mobile communication terminal and multi-media message that the mobile communication terminal received from other mobile communication terminals.

9. The method according to claim 6, wherein the preset multi-media message is stored in the locking apparatus.
